(19) United States
(12) Patent Application Publication
(10) Pub. No.: US 2004/0012455 A1
(43) Pub. Date: Jan. 22, 2004

(54) Nonreciprocal circuit device

(76) Inventors: Takamitsu Shibayama, Fukushima-ken (JP); Toshio Takahashi, Niigata-ken (JP); Hitoshi Onishi, Niigata-ken (JP)

Correspondence Address: BRINKS HOFER GILSON & LIONE, P.O. BOX 10395, CHICAGO, IL, 60611, US

(21) Appl. No.: 10/385,200

(22) Filed: Mar. 10, 2003

(30) Foreign Application Priority Data
Mar. 13, 2002 (JP) 2002-069083

(51) Int. Cl. H01P 1/32

(52) U.S. Cl. 333/1.1; 333/24.2

(57) ABSTRACT

A nonreciprocal circuit device in which a common electrode is arranged on a plate-shaped magnetic material, three center conductors which extend in three directions from the common electrode are bent in such a manner as to cover the plate-shaped magnetic substance, the center conductors intersect one another at a predetermined angle, capacitors are each connected to one end of each of the center conductors, wherein the capacitance of one of the center capacitors is larger than the capacitance of the other center conductor.

### BACKGROUND OF THE INVENTION

1. Field of the Invention

The present invention relates to a nonreciprocal circuit device, such as an isolator, a circulator, etc., used in a high-frequency microwave band, etc.

2. Description of the Related Art

A concentrated-constant isolator is a high-frequency component having functions for passing a signal without loss in the direction of transmission and for blocking the passing of the signal in the opposite direction, and is used in a transmission circuit section of a mobile communication device such as a cellular phone. As an example of such an isolator, there is an isolator having a configuration shown in FIG. 14.

A conventional isolator shown in FIG. 14 comprises a magnetic assembly 50 and a permanent magnet 56 as main components. The magnetic assembly 50 comprises a magnetic material 55 made of ferrite in the shape of a flat circular plate, a common electrode 54 made of a metal plate, provided on the bottom surface of the magnetic material 55, and a first center conductor 51, a second center conductor 52, and a third center conductor 53, which extend in three directions from the common electrode 54 and which are wound around the obverse-surface side of the magnetic material 55.

Each of the first, second, and third center conductors 51 to 53 is bent along the magnetic material 55, and is overlaid at an intersection angle of approximately 120° with one another on the obverse-surface side of the magnetic material 55. Although not shown in the figure, the center conductors 51, 52, and 53 are individually insulated with insulation sheets on the obverse-surface side of the magnetic material 55.

The position relationships among the center conductors 51 to 53 will now be described. As shown in FIG. 14, the first center conductor 51 is arranged at a position which is closest to the magnetic material 55, next, the third center conductor 53 is overlaid on the first center conductor 51, and the second center conductor 52 is overlaid on the third center conductor 53.

The front-end portion of each of center conductors 51, 52, and 53 is arranged so as to protrude over the side of the magnetic material 55, thereby forming port parts P1, P2, and P3. Then, rectifying capacitors C1, C2, and C3 are connected to the port parts P1, P2, and P3, respectively. A terminating resistor R is connected to the port part P3 via the capacitor C3. The above components, together with the permanent magnet 56, are housed in a magnetic-material yoke which forms a magnetic circuit, so that a DC magnetic-field can be applied to the magnetic assembly 50 by the permanent magnet 56, thereby forming an isolator. In this isolator, the port P1 serves as an input terminal, and the port P2 serves as an output terminal.

The center conductors 51 to 53 are sequentially provided so as to be integrated at the common electrode 54 which serves as a grounding part, and extend in three directions from the common electrode 54. These center conductors 51 to 53 are configured so as to be assembled with high precision at a predetermined angle with respect to the magnetic material 55. Each of the center conductors 51 to 53, wound around the obverse-surface side of the magnetic material 55, receives a DC magnetic-field from the permanent magnet 56, and thus functions as an inductance. The center conductors 51 to 53 have unique inductances L1, L2, and L3, respectively.

Therefore, in the conventional isolator, as a result of the inductances L1 to L3 being connected to the capacitors C1 to C3 (capacitances Cap1 to Cap3), respectively, an equivalent LC circuit is formed for each of the center conductors 51 to 53. In particular, in the conventional isolator, it is preferable that, in order to suppress the insertion loss, the product (L1×Cap1) of the inductance and the capacitance of the first center conductor 51 (input side) matches the product (L2×Cap2) of the inductance and the capacitance of the second center conductor 52 (output side).

However, in the conventional isolator, as is clear from the position relationships among the center conductors, at the intersection of the center conductors 51 to 53, since the first center conductor 51 is positioned between the second center conductor 52 and the magnetic material 55, the second center conductor 52 is positioned further away from the magnetic material 55 than the first center conductor 51. For this reason, the inductance L2 of the second center conductor 52 is lower than the inductance L1 of the first center conductor 51. Therefore, if the capacitors C1 and C2 having the same capacitance are used, the center frequencies of the reflection coefficients in the first and second center conductors 51 and 52 become different from each other, thus causing the problem of increased insertion loss and decreased signal transmission efficiency.

### SUMMARY OF THE INVENTION

The present invention has been made in view of the above-described circumstances. An object of the present invention is to provide a nonreciprocal circuit device having superior signal transmission efficiency by suppressing insertion loss.

To achieve the above-mentioned object, the present invention provides a nonreciprocal circuit device comprising: a plate-shaped magnetic-material; a common electrode arranged on one side surface of the plate-shaped magnetic-material; three center conductors which extend in three directions from the outer peripheral portion of the common electrode, said three center conductors being bent over the other side surface of said plate-shaped magnetic-material in such a manner as to cover the plate-shaped magnetic-material, and the center conductors mutually intersecting at a predetermined angle on said other side surface; and capacitors, each one being connected to a corresponding center conductor, wherein, with regard to one of a pair of center conductors among the three center conductors, the capacitance of the capacitor connected to one of the center conductors which intersects in a portion further away from said plate-shaped magnetic-material among the pairs of center conductors is larger than the capacitance of the capacitor connected to the other center conductor.

According to the nonreciprocal circuit device of the present invention, since the capacitance of the capacitor connected to one of the center conductors which intersects at a portion away from the plate-shaped magnetic-material is larger than the capacitance of the capacitor connected to the other center conductor which intersects at a portion closer to the plate-shaped magnetic material, the center frequencies of the reflection coefficients in a pair of center conductors can be made to match with each other. This makes it possible to reduce the insertion loss of the nonreciprocal circuit device and to improve the signal transmission efficiency. The “center frequency” is a frequency when the reflection coefficient indicates a minimum value.

In the nonreciprocal circuit device of the present invention, when the capacitance of the capacitor connected to one of the center conductors is denoted as Cap1 and the capacitance of the capacitor connected to the other center conductor is denoted as Cap2, the capacitance difference expressed by (Cap1−Cap2)/Cap1×100% is preferably in a range of 1% to 10%.

Furthermore, in the nonreciprocal circuit device of the present invention, more preferably, the capacitance difference is in a range of 2% to 6%, and, still more preferably, the capacitance difference is in a range of 2.2% to 5.5%.

According to the nonreciprocal circuit device of the present invention, since the capacitance difference between the capacitors C1 and C2 is in the above-described range, it is possible to cause the center frequencies of the reflection coefficients of a pair of center conductors to match each other. As a result, the insertion loss of the nonreciprocal circuit device can be reduced to improve the signal transmission efficiency.

In the nonreciprocal circuit device of the present invention, regarding the three center conductors, when the center conductors which are closer to the plate-shaped magnetic-material at the intersection are assumed to be the third center conductor, the second center conductor, and the first center conductor in sequence, preferably, the capacitance of the capacitor connected to the first center conductor is larger than the capacitance of the capacitor connected to the second center conductor, and the capacitance of the capacitor connected to the second center conductor is larger than the capacitance of the capacitor connected to the third center conductor.

According to the nonreciprocal circuit device of the present invention, since the capacitances of the capacitors connected to the three center conductors are set so as to be larger in the order the center conductors are overlaid, the center frequencies of the reflection coefficients in each center conductor can be made to match with each other. As a result, it is possible to reduce the insertion loss of the center conductor and to improve the signal transmission efficiency.

As described above, in the nonreciprocal circuit device of the present invention, for the pair of center conductors, the frequencies at which the reflection coefficient in each center conductor becomes a minimum are made to match with each other.

Furthermore, as described above, in the nonreciprocal circuit device of the present invention, for the three center conductors, the frequencies at which the reflection coefficient in each center conductor becomes a minimum are made to match with one another.

According to the nonreciprocal circuit device of the present invention, since the center frequencies of the reflection coefficients in each center conductor are made to match with each other, it is possible to reduce insertion loss and to improve the signal transmission efficiency.

### BRIEF DESCRIPTION OF THE DRAWINGS

FIG. 1 is a perspective view showing the essential portion of an isolator according to a first embodiment of the present invention;

FIG. 2 is a development view of a common electrode, and first, second, and third center conductors of the isolator shown in FIG. 1;

FIG. 3 is an exploded, perspective view showing the isolator according to the first embodiment of the present invention;

FIG. 4 is a circuit diagram showing an example of a circuit configuration of a cellular phone in which the isolator according to the first embodiment of the present invention is incorporated.

FIG. 5 is a schematic view showing the operating principles of the isolator according to the first embodiment of the present invention;

FIG. 6 is a plan view showing a state in which a portion of an isolator according to a second embodiment of the present invention is removed;

FIG. 7 is a sectional view showing the isolator according to the second embodiment of the present invention;

FIG. 8 is a plan view showing an example of a plate-shaped magnetic material used in the isolator according to the second embodiment of the present invention;

FIG. 9 is a development view of an electrode part used in the isolator according to the second embodiment of the present invention;

FIG. 10 is a graph showing the frequency dependence of reflection coefficients S11 and S22 of an isolator of experiment example 1;

FIG. 11 is a graph showing the frequency dependence of insertion loss and isolation values of the isolator of experiment example 1;

FIG. 12 is a graph showing the frequency dependence of reflection coefficients S11 and S22 of an isolator of experiment example 2;

FIG. 13 is a graph showing the frequency dependence of insertion loss and isolation values of the isolator of experiment example 2; and

FIG. 14 is a perspective view showing the essential portion of a conventional isolator.

### DESCRIPTION OF THE PREFERRED EMBODIMENTS

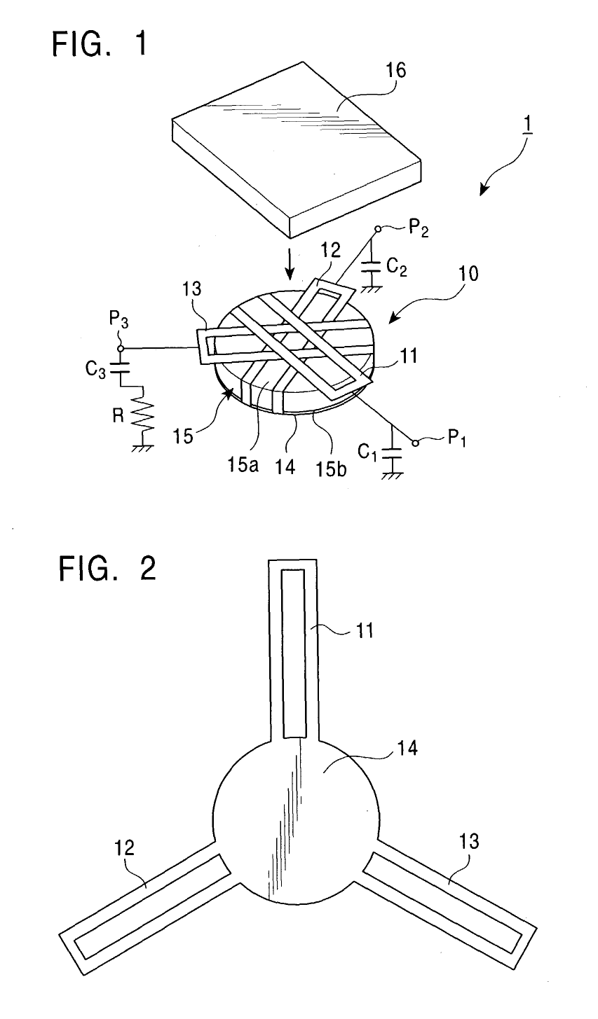

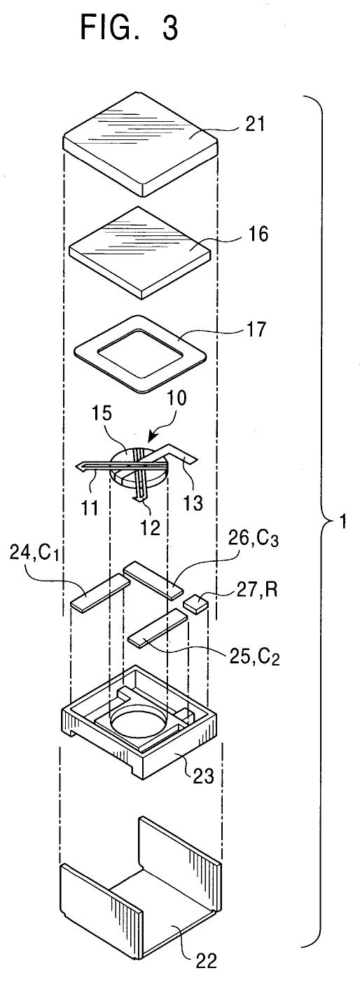

The preferred embodiments of the present invention will now be described below with reference to the drawings. FIG. 1 is a perspective view showing the essential portion of an isolator, which is an example of a nonreciprocal circuit device, according to a first embodiment of the present invention. FIG. 3 is an exploded, perspective view of the isolator.

An isolator 1 shown in FIG. 1 comprises a magnetic assembly 10 and a permanent magnet 16 as main components. The magnetic assembly 10 comprises a plate-shaped magnetic material 15 made of ferrite in the shape of a flat circular plate, a common electrode 14, made of a metal plate, provided on the bottom surface (one surface) 15b, and a first center conductor 11, a second center conductor 12, and a third center conductor 13, which extend in three directions from the common electrode 14 and which are wound around the obverse surface (the other surface) 15a side of the plate-shaped magnetic material 15.

The first, second, and third center conductors 11 to 13 are each bent along the magnetic material 15, and are overlaid at an intersection angle of approximately 120° with one another on the obverse-surface (the other surface) 15a side of the magnetic material 15. Although not shown in the figure, the center conductors 11 to 13 are individually insulated with insulation sheets on the obverse-surface 15a side of the magnetic material 15.

The position relationships among the center conductors 11 to 13 will now be described. As shown in FIG. 1, the second center conductor 12 is arranged at a position which is closest to the magnetic material 15, next, the third center conductor 13 is overlaid on the second center conductor 12, and the first center conductor 11 is overlaid on the third center conductor 13. That is, the first center conductor 11 is arranged further away from the plate-shaped magnetic material 15 than the second center conductor 12.

The front-end portion of each of the center conductors 11 to 13 is arranged so as to protrude over the side of the magnetic material 15, forming port parts P1, P2, and P3. Then, rectifying capacitors C1, C2, and C3 are connected to the port parts P1 to P3, respectively. A terminating resistor (resistance element) R is connected to the port part P3 via the capacitor C3. The above components, together with the permanent magnet 16, are housed in a magnetic-material yoke which forms a magnetic circuit, so that a DC magnetic-field can be applied to the magnetic assembly 10 by the permanent magnet 16, thereby forming an isolator. In this isolator, the port part P1 serves as an input portion, and the port part P2 serves as an output portion. If the terminating resistor R is removed, the device functions as a circulator.

As shown in FIG. 2, the center conductors 11 to 13 are sequentially provided so as to be integrated at the common electrode 14 which serves as a grounding part, and extend in three directions from the common electrode 14. Then, as shown in FIG. 1, these center conductors 11 to 13 are configured so as to be assembled with high precision at a predetermined angle with respect to the magnetic material 15. Each of the center conductors 11 to 13, wound around the obverse-surface side of the magnetic material 15, receives a DC magnetic field from the permanent magnet 16, and thus function as an inductance, and the center conductors 11 to 13 have unique inductances L1, L2, and L3, respectively.

In the isolator 1 shown in FIG. 1, at the intersection of the center conductors 11 to 13, the second center conductor 12, the third center conductor 13, and the first center conductor 11 are overlaid on the plate-shaped magnetic material 15 in this order, and the shape of each of the center conductors 11 to 13 is almost the same. Therefore, the inductance of each of the center conductors 11 to 13 decreases as it is further away from the permanent magnet 16. That is, the inductances are ordered as follows: L2>L3>L1.

For the capacitances Cap1 and Cap2 of the capacities C1 and C2, it is preferable that the capacitance Cap1 of the capacitor C1 connected to the first center conductor 11 be larger than the capacitance Cap2 of the capacitor C2 connected to the second center conductor 12. As a result of increasing the capacitance Cap1 of the capacitor C1 being than the capacitance Cap2 of the capacitor C2, based on the relation (L2>L1) of the inductances of the first and second center conductors 11 and 12, the center frequency of the reflection coefficient in the first center conductor 11 can be made to match the center frequency of the reflection coefficient in the second center conductor 12. The “center frequency” refers to a frequency at which the reflection coefficient becomes a minimum. As a result, it is possible to reduce insertion loss and to improve the signal transmission efficiency.

For the relationship between the capacitance Cap1 of the capacitor C1 connected to the first center conductor 11 and the capacitance Cap2 of the capacitor C2 connected to the second center conductor 12, it is preferable that the capacitance difference expressed by the equation (Cap1−Cap2)/Cap1×100% be in a range of 1% to 10%, and, more preferably, be in a range of 2% to 6%.

If the capacitance difference is less than 1%, the center frequency of the reflection coefficient in the first center conductor 11 becomes higher than the center frequency in the second center conductor 12. If the capacitance difference exceeds 10%, the center frequency of the reflection coefficient in the first center conductor 11 becomes lower than the center frequency in the second center conductor 12. In both cases, their center frequencies cannot be made to match, and the insertion loss becomes larger, which is undesirable.

The entire configuration of the isolator 1 of this embodiment will now be described. As shown in FIG. 3, the construction is formed in such a way that, inside a closed magnetic circuit (magnetic-material yoke) formed of an upper yoke 21 and a lower yoke 22, in other words, between the upper yoke 21 and the lower yoke 22, a permanent magnet 16 in the shape of a rectangular plate, a spacer member 17, a magnetic assembly 10, capacitor plates 24, 25, and 26, a terminating resistor 27 (R), and a resin case 23 for housing the above components are housed. The magnetic assembly 10 is configured in such a manner that the first, second, and third center conductors 11 to 13 are wound around the plate-shaped magnetic material 15. Then, the capacitor plate 24 is mounted on the first center conductor 11, the capacitor plate 25 is mounted on the second center conductor 12, and the capacitor plate 26 and the terminating resistor 27 are mounted on the third center conductor 13.

The capacitor C1 shown in FIG. 1 is incorporated in the capacitor plate 24, the capacitor C2 is incorporated in the capacitor plate 25, the capacitor C3 is incorporated in the capacitor plate 26, and the terminating resistor R is incorporated in the terminating resistor 27.

According to the isolator 1 of this embodiment, since the capacitance Cap1 of the capacitor C1 connected to the first center conductor 11 which intersects at a portion further away from the plate-shaped magnetic material 15 is larger than the capacitance Cap2 of the capacitor C2 connected to the second center conductor 12 which intersects at a portion closer to the plate-shaped magnetic material 15, the center frequencies of the reflection coefficients in the center conductors 11 and 12 can be made to match with each other. This makes it possible to reduce the insertion loss of the isolator 1 and to improve the signal transmission efficiency.

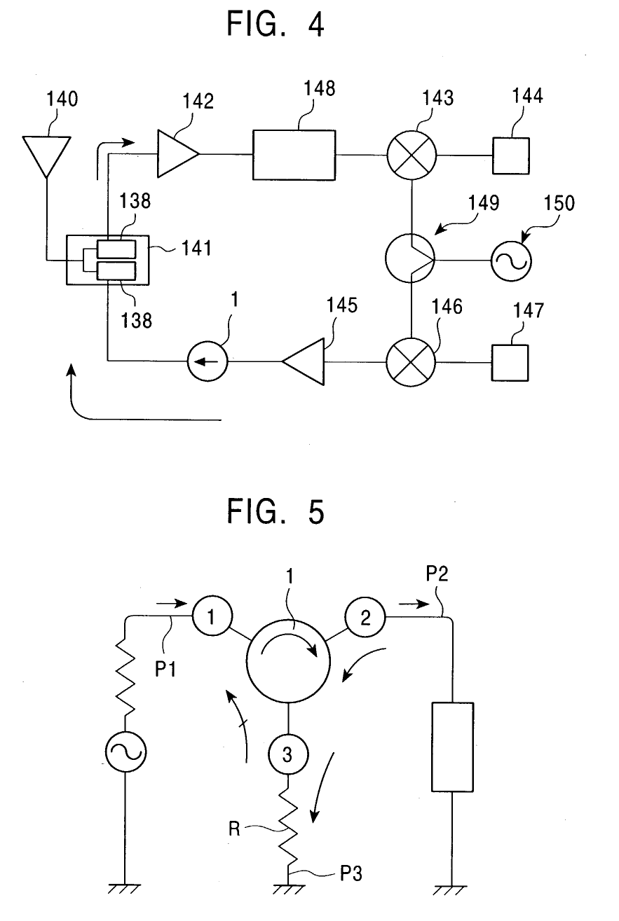

The circuit diagram shown in FIG. 4 shows an example of the circuit configuration of a cellular phone in which the isolator 1 of this embodiment is incorporated. In the circuit configuration of this example, the construction is formed in such a way that a duplexer (antenna duplexer) 141 is connected to an antenna 140; an IF circuit 144 is connected to the output side of the duplexer 141 via a low-noise amplifier 142, an interstage filter 148, and a mixed circuit 143; an IF circuit 147 is connected to the input side of the duplexer 141 via the isolator 1 of this embodiment, a power amplifier 145, and a mixed circuit 146; and a local oscillator 150 is connected to the mixed circuits 143 and 146 via a distribution transformer 149.

The duplexer 141 is configured so as to incorporate, for example, two ladder SAW filter devices 138. The terminals on the input side of the ladder SAW filter devices 138 and 138 are each connected to the antenna 140, the terminal of the output side of one of the ladder SAW filter devices 138 is connected to the low-noise amplifier 142, and the terminal on the output side of the other ladder SAW filter device 138 is connected to the isolator 1.

The isolator 1 of the above-described configuration is incorporated in a circuit of a cellular phone such as that shown in FIG. 4 and is used, so that it functions so as to pass a signal from the isolator 1 to the duplexer 141 with a low loss, but functions so as to block a signal in the opposite direction by increasing the loss. As a result, it is possible to obtain the effect such that an unwanted signal such as noise on the amplifier 145 side is not reversely input to the amplifier 145.

FIG. 5 shows the operating principles of the isolator 1 having the configuration shown in FIGS. 1 to 3. The isolator 1 incorporated in the circuit shown in FIG. 5 passes a signal from the first port P1 (input side) indicated by reference numeral \mathring{1} to the port P2 (output side) indicated by reference numeral \mathring{2}, but absorbs a signal from the first port P2 indicated by reference numeral \mathring{2} to the third port P3 indicated by reference numeral \mathring{3} by attenuating the signal by the terminating resistor R, and blocks a signal from the third port P3 indicated by reference numeral \mathring{3} on the terminating resistor R side to the first port P1 indicated by reference numeral \mathring{1}. Therefore, when the isolator 1 is incorporated in the circuit shown in FIG. 4, the above-described advantages can be obtained.

The range of the application of the nonreciprocal circuit device of this embodiment is not limited to the above-described embodiment, and can also be applied to a second embodiment described below.

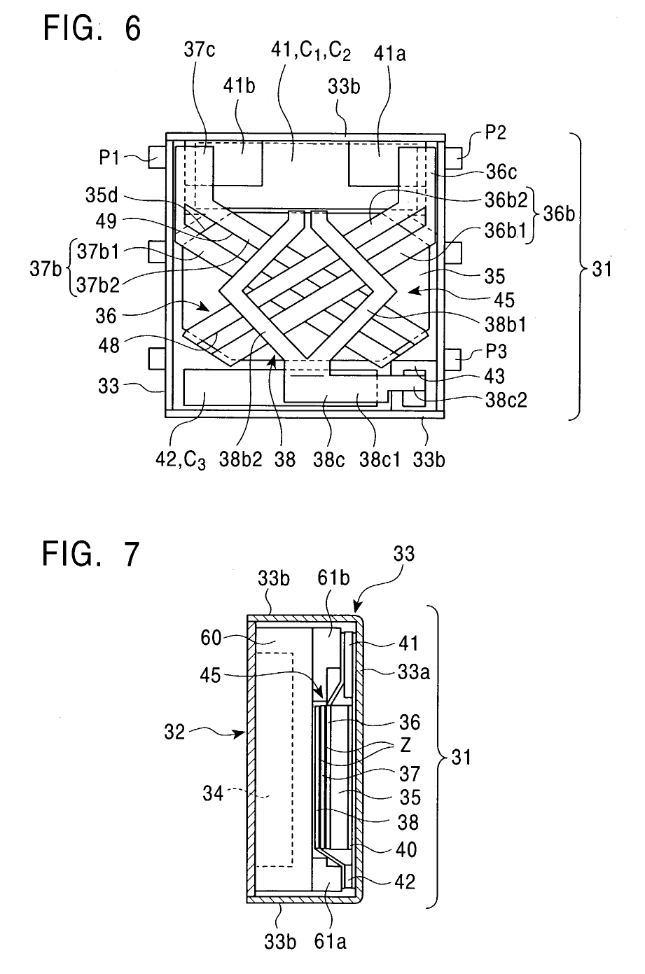

FIGS. 6 to 9 show an isolator, which is an example of a nonreciprocal circuit device, according to a second embodiment of the present invention. An isolator 31 of this embodiment is configured in such a manner that, within a closed magnetic circuit formed of an upper yoke 32 and a lower yoke 33, a permanent magnet 34, a plate-shaped magnetic material 35 formed from ferrite, center conductors 36, 37, and 38, a common electrode 40 to which the center conductors 36, 37, and 38 are connected, capacitor substrates 41 and 42 arranged around the magnetic material 35, and a terminating resistor 43 are provided.

The upper yoke 32 and the lower yoke 33, formed from a ferromagnetic material such as soft iron, are formed in a rectangular box shape. It is preferable that the obverse and reverse surfaces of these yokes be coated with Ag-plated conduction layers. By fitting together the yokes 32 and 33, a box-shaped closed magnetic circuit is formed.

In the space surrounded by the upper yoke 32 and the lower yoke 33, that is, within the closed magnetic circuit formed of the upper yoke 32 and the lower yoke 33, a magnetic assembly 45 comprising a plate-shaped magnetic material 35, three center conductors 36, 37, and 38, and a common electrode 40 to which these center conductors 36, 37, and 38 are connected is housed.

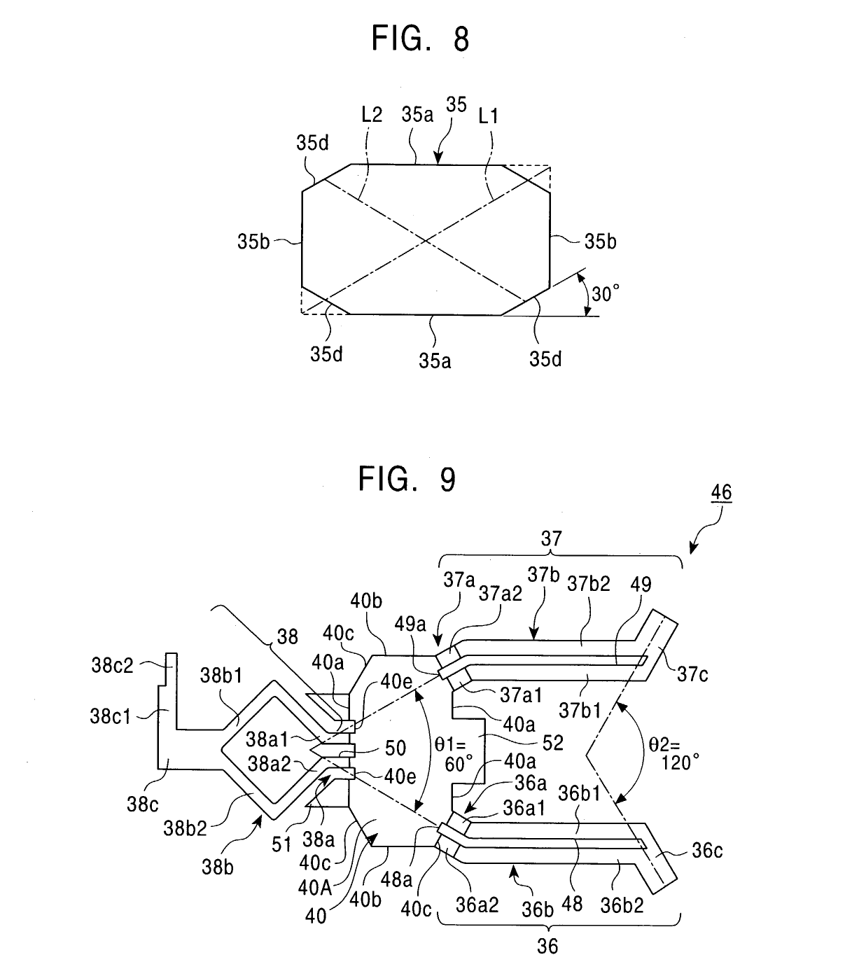

The plate-shaped magnetic material 35 is formed from ferromagnetic material such as YIG ferrite, and, as shown in FIG. 8, is formed in the shape of substantially a rectangular plate, which is landscape in a plan view. More specifically, the magnetic material 35 is formed in the shape of substantially a rectangular plate, which is formed of two opposing landscape longer sides 35a and 35a, shorter sides 35b and 35b, which face the longer sides 35a and 35a at right angles, and four inclination sides 35d which are positioned in portions near the both-end portions of the longer sides 35a and 35a, which are inclined at an angle of 150° with respect to each longer side 35a (which are inclined at an angle of 30° with respect to the extension line of the longer side 35a), and which are connected to the corresponding shorter sides 35b. Therefore, at the four corner portions in a plan view of the plate-shaped magnetic material 35, inclination surfaces (receiving surfaces) 35d which are inclined by 150° with respect to the corresponding longer sides 35a (which are inclined 120° with respect to the shorter sides 35b) are formed.

The three center conductors 36 to 38, and the common electrode 40 are integrally formed, as shown in the development view of FIG. 9, and the electrode part 46 is formed by the three center conductors 36 to 38 and the common electrode 40 as main components. The common electrode 40 is formed from a main-unit part 40A made of a metal plate, which is substantially similar in shape to the plate-shaped magnetic material 35 in a plan view. That is, the main-unit part 40A is formed in the shape of substantially a rectangle (rectangular shape), which is formed of two opposing longer sides 40a and 40a, shorter sides 40b and 40b, which face the longer sides 40a and 40a at right angles, and four inclination sides 40c which are positioned in portions near the both-end portions of the longer sides 40a and 40a, which are inclined at an angle of 150° with respect to each longer side 40a, and which are inclined at an angle of 120° with respect to the shorter sides 40b.

Then, from the two inclination sides 40c on one of the longer sides among the inclination sides 40c at the four corner portions of the common electrode 40, the first center conductor 36 and the second center conductor 37 extend. First, from one of the two inclination sides 40c, the first center conductor 36 formed of a first base conductor 36a, a first central conductor 36b, and a first front-end conductor 36c extend, whereas, from the other inclination side 40c, the second center conductor 37 formed of a second base conductor 37a, a second central conductor 37b, and a second front-end conductor 37c extends. Both the base conductor 36a and 37a are formed to have the same width as that of the inclination sides 40c so that the inclination sides 40c extend, and the base conductor 36a and 37a are provided in such a manner that their center axial lines are inclined at an inclination angle of 150° with respect to the longer sides 40a of the common electrode 40. Next, both the central conductors 36b and 37b are formed in parallel with the shorter sides 40b of the common electrode 40, that is, are formed at an inclination angle of 150° with respect to the center axial lines (length direction) of the base conductor 36a and 37a. Furthermore, both the front-end conductors 36c and 37c are inclined by 150° with respect to the longer sides 40a of the common electrode 40.

As a result of the above, as shown in FIG. 9, the angle θ1 formed by the center axial lines of the connection conductors 36a and 37a is 60°, and the angle θ2 formed by the center axial lines of the front-end conductors 36c and 37c is 120°.

Next, in the central portion of the first center conductor 36 along the width direction, a slit portion 48 which passes through the first base conductor 36a and the first central conductor 36b to reach the base end portion of the front-end conductor 36c is formed. As a result of forming the slit portion 48, the central conductor 36b is divided into two divided conductors 36bl and 36b2, and the base conductor 36a is also divided into two divided conductors 36a1 and 36a2. Similarly, a slit portion 49 is formed in the central portion of the second center conductor 37 along the width direction. As a result of forming the slit portion 49, the central conductor 37b is divided into two divided conductors 37b1 and 37b2, and the base conductor 37a is also divided into two divided conductors 37a1 and 37a2.

The end portion of the slit portion 48 on the common electrode 40 side passes through the connection conductor 36a to reach a position which is slightly deep from the outer peripheral portion of the common electrode 40, forming a recess portion 48a, so that the line length of the first center conductor 36 is slightly increased. Also, as a result of the end portion of the slit portion 49 on the common electrode 40 side passing through the connection conductor 37a to reach the outer peripheral portion of the common electrode 40, a recess portion 49a is formed, so that the line length of the second center conductor 37 is slightly increased.

On the other hand, in the central portion of the common electrode 40 on the other longer side 40a, the third center conductor 38 extends. The third center conductor 38 is formed of a third base conductor 38a, a third central conductor 38b, and a third front-end conductor 38c, which extend from the common electrode 40. The third base conductor 38a are formed of two divided conductors 38a1 and 38a2 in the shape of a short strip, which extend at approximately right angles from the central portion of the common electrode 40 on the longer side, and a slit 50 is formed between the two divided conductors 38a1 and 38a2. The third central conductor 38b is formed of a divided conductor 38b1 in the shape of a letter L in a plan view, which is connected to the divided conductor 38a1, and a divided conductor 38b2 in the shape of a letter L in a plan view, which is connected to the divided conductor 38a2. The divided conductor 38b1 and the divided conductor 38b2 extend from the divided conductors 38al and 38a2 in such a manner as to cause their central portions to be spaced apart so that the substantial conductor lengths of the divided conductors 38a1 and 38a2 are increased, and the rhombus central conductor 38b is formed of the divided conductor 38b1 and 38b2.

Furthermore, the front-end portions of the divided conductor 38b1 and 38b2 are integrally formed with the third front-end conductor 38c in the shape of a letter L. The third front-end conductor 38c is formed of a connection portion 38c1 which is formed in such a manner that the divided conductor 38b1 and 38b2 are formed integrally and extend in the same direction as that of the divided conductors 38a1 and 38a2, and a connection portion 38c2 which extends approximately at right angles to the connection portion 38c1.

On one of the longer sides 40a of the common electrode 40, at portions of both sides of the divided conductor 38al and 38a2 of the third center conductor 38, three recess portions 40e are formed in such a manner as to cut a portion of the longer side portions 40a of the common electrode 40, and as a result of forming these recess portions 40e, the line length of the third center conductor 38 is slightly increased. Furthermore, in one of the longer side portions 40a of the common electrode 40, outside the two recess portions 40e on both sides among the three recess portions 40e, that is, in a portion between the recess portions 40e and the inclination sides 40c, a trapezoidal support member 51 extends in a direction parallel to the divided conductor 38a1 and 38a2, and also, in the central portion on the other longer side portion 40a of the common electrode 40, a support member 52 in the shape of a rectangle in a plan view extends. The support members 51 and 52 serve as grounding electrodes of the capacitor substrates 41 and 42, and the support members 51 and 52 are connected to one side of the capacitor substrates 41 and 42, and the other side thereof is electrically connected to the front-end portions 36c, 37c, and 38c, as will be described later.

In the common electrode 40 configured as described above, the main-unit part 40A thereof is placed on the reverse surface 15b (one of the surfaces) of the plate-shaped magnetic material 35; and the first center conductor 36, the second center conductor 37, and the third center conductor 38 are bent over the obverse surface 15a (the other surface) of the plate-shaped magnetic material 35 and are placed in the plate-shaped magnetic material 35, forming a magnetic assembly 45 together with the plate-shaped magnetic material 35. More specifically, the divided conductors 36a1 and 36a2 of the first center conductor 36 are bent along the edge of one inclination surface 35d of the plate-shaped magnetic material 35; the divided conductors 37a1 and 37a2 of the second center conductor 37 are bent along-the edge of the other inclination surface 35d of the plate-shaped magnetic material 35; the divided conductor 38a1 and 38a2 of the third center conductor 38 are bent along the edge of the longer side 35a of the plate-shaped magnetic material 35; the center conductor 36a of the first center conductor 36 is placed on the diagonal line of the surface of the plate-shaped magnetic material on the obverse-surface side (the other surface) of the plate-shaped magnetic material 35; the central conductor 37b of the second center conductor 37 is placed along the diagonal line on the surface of the plate-shaped magnetic-material on the obverse-surface side (the other surface) of the plate-shaped magnetic material 35; and the central conductor 38b of the third center conductor 38 is placed on the central portion of the surface portion of the plate-shaped magnetic material 35, thereby the common electrode 40 is placed in the plate-shaped magnetic material 35, forming the magnetic assembly 45.

The diagonal line referred to herein is such that, when the plate-shaped magnetic material 35 is viewed in a plan view as shown in FIG. 8, the position at which the extension line of each longer side 35a and the extension line of each shorter side 35b intersect is assumed to be an apex of the plate-shaped magnetic material 35 substantially in the shape of a rectangle, and the line segments connecting the opposing apexes among the four apexes are defined as diagonal lines L1 and L2.

Furthermore, the conductor portions 38b1 and 38b2 are placed on the obverse-surface side of the plate-shaped magnetic material 35. The length of the divided conductor 38b1 or the divided conductor 38b2 which is placed on the obverse-surface side of the plate-shaped magnetic material 35 is preferably 105% or more of the longitudinal width (the width along the width direction of the plate-shaped magnetic material 35 in the shape of a rectangle in landscape) of the plate-shaped magnetic material 35 shown in FIG. 8. As a result of the above, the substantial conductor lengths of the divided conductor 38b1 and 38b2 are increased, and a lower frequency and a size reduction of a nonreciprocal circuit device can be achieved at the same time. The recess portions 40e, 48a, and 49a may be provided as required, and may not be provided.

As a result of placing the first to third center conductors 36, 37, and 38 on the obverse-surface side of the plate-shaped magnetic material 35, as shown in FIG. 6, the first center conductor 36 and the second center conductor 37 are individually placed in an overlaid manner along the diagonal lines L1 and L2 of the plate-shaped magnetic material 35, and the first central conductor 36b and the second central conductor 37b are placed in an overlaid manner so as to intersect at an inclination angle of 120° in a plan view on the surface of the plate-shaped magnetic material 35. In a state in which the first to third center conductors 36b, 37b, and 38b are overlaid on one another, all the portions where the divided conductors 36b1 and 36b2 of the first central conductor 36b and the divided conductors 37b1 and 37b2 of the central conductor 37b are overlaid are placed in such a manner as to be deviated in a plan view on the obverse-surface side of the plate-shaped magnetic material 35, and the portions where the divided conductors 36b1 and 36b2 and the divided conductors 37bl and 37b2 are overlaid is placed in such a manner that these do not overlap on the surface of the plate-shaped magnetic material 35.

The position relationships at the intersection of the center conductors 36 to 38 will now be described. As shown in FIG. 6, the second center conductor 37 is placed closest to the plate-shaped magnetic material 35, next, the first center conductor 36 are overlaid on the second center conductor 37, and the third center conductor 38 is overlaid on the first center conductor 36. That is, the first center conductor 36 is placed further away from the plate-shaped magnetic material 35 than the second center conductor 37.

In the isolator 31 of this embodiment, at the portion where the first and second center conductors 36 and 37 intersect, the second center conductor 37 and the first center conductor 36 are overlaid on the plate-shaped magnetic material 35 in this order, and the shapes of the center conductors 36 and 37 are substantially the same. Therefore, the inductances L1 and L2 of the first and second center conductors 36 and 37 decrease as these are further away from the plate-shaped magnetic material 35. That is, the inductances are ordered as follows: L2>L1.

The divided conductor 38b1 and 38b2 of the third central conductor 38b are placed so as to avoid the portions where the divided conductors 36b1 and 36b2 and the divided conductors 37b1 and 37b2 are overlaid. Therefore, on the surface of the plate-shaped magnetic material 35, the divided conductors 36b1 and 36b2 and the divided conductor 38b1 and 38b2 are placed in such a manner that three conductors are not overlaid though there is a case in which two conductors are overlaid among the combinations thereof.

Although omitted in FIG. 6, as briefly shown in FIG. 7, insulation sheets Z are interposed between the first center conductor 36 and the second center conductor 37 and between the third center conductor 38 and the second center conductor 37, so that the center conductors 36, 37, and 38 are electrically insulated individually.

The magnetic assembly 45 is placed in the central portion of the bottom of the lower yoke 33; the plate-shaped capacitor substrates 41 and 42, which are elongated in a plan view, having a thickness which is approximately half of that of the plate-shaped magnetic material 35 are housed in both-side portions of the magnetic assembly 45 on the bottom side of the lower yoke 33; and the terminating resistor 43 is housed on one of the side portions of the capacitor substrate 42. More specifically, the length of the plate-shaped magnetic material 35 of the magnetic assembly 45 is formed substantially the same as the inner width of the lower yoke 33, and the width of the plate-shaped magnetic material 35 (the width in a direction intersecting at right angles to the length direction) is formed to be smaller than the inner width of the lower yoke 33. As a result, in a state in which the plate-shaped magnetic material 35 is housed inside the lower yoke 33 in such a manner as to be landscape in a plan view as shown in FIG. 6, space portions capable of housing the capacitor substrates 41 and 42 are formed on both sides in the width direction of the plate-shaped magnetic material 35, and the capacitor substrates 41 and 42 and the terminating resistor 43 are housed in the space portions.

Then, the front-end conductor 36c of the first center conductor 36 is electrically connected to an electrode part 41a formed on one of the side end portions of the capacitor substrate 41; the front-end conductor 37c of the second center conductor 37 is electrically connected to an electrode part 41b formed on the other side end portion of the capacitor substrate 41; the front-end conductor 38c of the third center conductor 38 is electrically connected to the capacitor substrate 42 and the terminating resistor 43; and the capacitor substrates 41 and 42 and the terminating resistor 43 are connected to the magnetic assembly 45. If the terminating resistor 43 is not connected, the device functions as a circulator.

At the end portion of the capacitor substrate 41 to which a portion of the front-end conductor 37c is connected, a first port P1 for the nonreciprocal circuit device 31 is formed; at the end portion of the capacitor substrate 42 to which a portion of the first front-end conductor 36c is connected, a second port P2 for the nonreciprocal circuit device 31 is formed; and the end portion of the terminating resistor 43 to which a portion of the first front-end conductor 38c is connected is formed as a third port P3 for the nonreciprocal circuit device 31.

The capacitor substrate 41 has incorporated therein a capacitor C1 connected to the first center conductor 36 and a capacitor C2 connected to the second center conductor 37. The capacitor substrate 42 has incorporated therein a capacitor C3 connected to the third center conductor 38.

The capacitance Cap1 of the capacitor C1 connected to the first center conductor 36 is preferably larger than the capacitance Cap2 of the capacitor C2 connected to the second center conductor 37. As a result of increasing the capacitance Cap1 of the capacitor C1 than the capacitance Cap2 of the capacitor C2, on the basis of the relation (L2>L1) of the inductances of the first and second center conductors 36 and 37, the center frequency of the reflection coefficient in the first center conductor 36 can be made to match the center frequency of the reflection coefficient in the second center conductor 37. The “center frequency” refers to a frequency at which the reflection coefficient becomes a minimum. As a result, it is possible to reduce insertion loss and to improve signal transmission efficiency.

Regarding the relationship between the capacitance Cap1 of the capacitor C1 connected to the first center conductor 36 and the capacitance Cap2 of the capacitor 2 connected to the second center conductor 37, for the same reason as in the case of the first embodiment, the capacitance difference expressed by the equation (Cap1−Cap2)/Cap1×100% is preferably in a range of 1% to 10%, more preferably, the capacitance difference is in a range of 2% to 6%, and, still more preferably, the capacitance difference is in a range of 2.2% to 5.5%.

In the space portion between the lower yoke 33 and the upper yoke 32, the magnetic assembly 45 is formed to have a thickness which occupies approximately a half of the thickness of that space portion, a spacer member 60 is housed in the space portion closer to the upper yoke 32 than the magnetic assembly 45, and the permanent magnet 34 is provided in the spacer member 60.

In the isolator 31 of this embodiment shown in FIGS. 6 to 9, in addition to the advantages which are the same as the advantages described in the first embodiment, the following advantages can be obtained.

More specifically, since both the center conductor 36 and the second center conductor 37 are bent via the receiving surfaces 35d and 35d in the form of a plane, of the plate-shaped magnetic material 35, and since the third center conductor 38 is bent along the longer side 35a of the plate-shaped magnetic material 35, the bent portions of the central conductors 36b, 37b, and 38b in the center conductors 36, 37, and 38 are folded on the obverse-surface side of the plate-shaped magnetic material 35 at an accurate angle, for example, at an angle of 120° in the center conductors 36 and the second center conductor 37. That is, since an folding operation is performed via the straight-line portion of the edge of the receiving surface 35d in the form of a plane, it becomes possible to easily bend the first central conductor 36b and the central conductor 37b in such a manner that they intersect accurately at an angle of 120° on the obverse-surface side of the plate-shaped magnetic material 35. Therefore, the signal input to the plate-shaped magnetic material 35 from the center conductor on the input side can be effectively propagated to the output side, and thus low-loss and wide-range passing characteristics can be exhibited. Therefore, it is possible to reliably obtain appropriate magnetic characteristics of the magnetic assembly 45.

The central conductors 36b, 37b, and 38b folded on the obverse-surface side of the plate-shaped magnetic material 35 are overlaid as shown in FIG. 6, and in this overlaid state, the divided conductors 36b1, 36b2, 37b1, 37b2, 38b1, and 38b2, which are divided into two portions in each of the center-portion conductors 36b, 37b, and 38b, are overlaid individually. However, for the portion where these divided conductors 36b1 to 38b2 are overlaid, a portion of only any two divided conductors is formed, and three divided conductors are not overlaid. This is because an overlay construction in which the two center conductors 36 and 37 are divided into two portions and the central conductor 38b is widened is formed so as to be capable of avoiding an overlay portion for the central conductors 36b and 37b.

As a result of forming such an overlay construction, it is possible to prevent three divided conductors from overlaying one another. This makes it possible to evenly press the overlaid portion of the central conductors 36b, 37b, and 38b when the central conductors 36b, 37b, and 38b are pressed to the plate-shaped magnetic material 35 at the bottom of the spacer member 60. Here, for example, when a portion where three divided conductors overlay occurs, since the portion where three divided conductors overlay becomes thicker than that of the portion where two divided conductors overlay, a strong pressing force of the spacer member 60 acts on the portion where the three divided conductors overlay, whereas the pressing force of the spacer member 60 does not sufficiently act on the portion where the two divided conductors overlay. Consequently, there is a high risk in that it is not possible that a pressing force is made to evenly act on the central conductors 36b, 37b, and 38b so as to evenly support all these conductors.

In the manner described above, since the divided conductors 38b1 and 38b2 of the central conductor 38b are divided in such a manner as to be non-parallel or parallel, and bent or curved, the signal input from the center conductor on the input side can be effectively propagated on the plate-shaped magnetic material 35 made of a high-frequency ferrite and can be output, thereby exhibiting wide-band passing characteristics.

In order to achieve a lower frequency, it is necessary to increase the length of the center conductors 36, 37, and 38 in order to increase the inductance. In the present invention, in the third central conductor 38b, the third center conductor 38 is bent or curved in a direction in which these are away from each other in the central portion along the length direction, or is parallel to each other, and bent or curved. As a result, the length of the third center conductor 38 is substantially increased, the inductance becomes larger, and a lower frequency and size reduction can be achieved at the same time.

In this embodiment, the main-unit part 40A of the electrode part 46 is formed into substantially the same shape in a plan view as that of plate-shaped magnetic material 35. As a result of the above, since the main-unit part 40A can contact the lower yoke 33 positioned therebelow at a large area, the resistance becomes lower, and the loss can be reduced.

As described above, in the root portion of each of the first center conductor 36, the second center conductor 37, and the third center conductor 38, the recess portions 48a, 49a, and 40e are formed, so that the line length of each center conductor is slightly increased. Therefore, the inductance of each of the center conductors 36, 37, and 38 is increased, and the area of the resonance capacitor can be decreased, in other words, there is the effect that the area of the capacitor substrates 41 and 42 can be decreased, thereby contributing to the size reduction of the entire nonreciprocal circuit device 31.

(First Embodiment)

For the isolator having the configuration shown in FIGS. 1 to 3, reflection coefficients, insertion losses, and isolation values in a case where the capacitances of the capacitors C1 and C2 were changed were measured.

In the isolator shown in FIGS. 1 to 3, as a plate-shaped magnetic-material, a magnetic material composed of yttrium iron garnet ferrite (YIG ferrite) in the shape of a circular plate having a diameter of 2 mm and a thickness of 0.35 mm was used. For the first, second, and third center conductors, copper foils having a line length of 2.4 mm, a substantial line width of 0.4 mm, and a thickness of 0.05 mm were used. The first, second, and third center conductors are formed so as to extend in three directions from a common electrode in the shape of a circular plate having a diameter of 2 mm and a thickness of 0.05 mm.

A common electrode was laminated on the bottom of the plate-shaped magnetic-material, and the first, second, and third center conductors were bent over the obverse-surface side of the plate-shaped magnetic-material, thereby a magnetic assembly shown in FIG. 1 was manufactured.

Next, the capacitor C1 was mounted on the first port P1 (input port), which is a front end of the first center conductor; the capacitor C2 was mounted on the port part P2 (output port), which is a front end of the second center conductor; and the capacitor C3 was mounted on the port part P3, which is a front end of the third center conductor; the terminating resistor R was mounted on the capacitor C3; and a permanent magnet was laminated on the plate-shaped magnetic-material. In this state, the above components were placed inside a closed magnetic circuit formed of an upper yoke and a lower yoke, thereby isolators of experiment example 1 and experiment example 2, shown in FIG. 1, were produced.

For the isolator of experiment example 1, the capacitance of the capacitor C1 was set to 7.2 pF, the capacitance of the capacitor C2 was set to 7.0 pF, the capacitance of the capacitor C3 was set to 8.0 pF, and the terminating resistance was set to 47 Ω. For the isolator of experiment example 2, the capacitances of the capacitors C1 and C2 were set to 5.2 pF, the capacitance of the capacitor C3 was set to 5.0 pF, and the terminating resistance was set to 47 Ω.

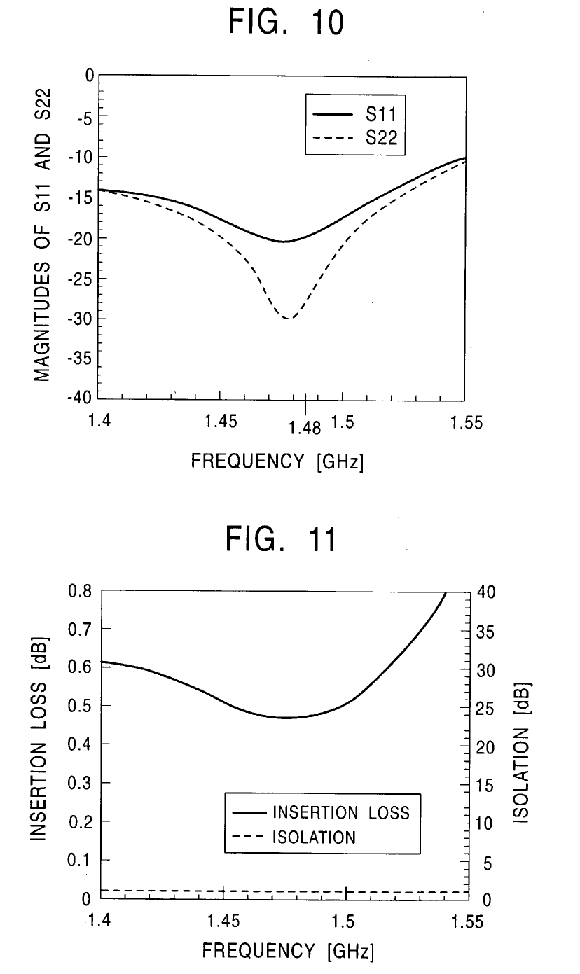

For the isolators of experiment example 1 and experiment example 2, a reflection coefficient S11 on the input side (first center conductor), a reflection coefficient S22 on the output side (second center conductor), insertion losses, and isolation values in the frequency band of 1.4 to 2 GHz were determined. FIGS. 10 to 13 show a reflection coefficient S11, a reflection coefficient S22, and the frequency dependence of the insertion loss and isolation values.

First, in the isolator of experiment example 1, as shown in FIG. 10, it can be seen that the center frequencies of the reflection coefficients S11 and S22 are each in the vicinity of 1.48 GHz, and the center frequencies approximately match. Furthermore, as shown in FIG. 11, the insertion loss becomes a minimum in a range in which the frequency is in a range of 1.45 to 1.5 GHz. The center frequency of FIG. 10 is within this range, and the optimum frequency ranges of the insertion loss and the reflection coefficients S11 and S22 match.

For this reason, the isolator of experiment example 1 can be operated at approximately the same frequency as the center frequencies of the reflection coefficients S11 and S22, and the signal transmission efficiency can be increased.

The capacitance difference between the capacitors C1 and C2 of experiment example 1 is approximately 2.8%.

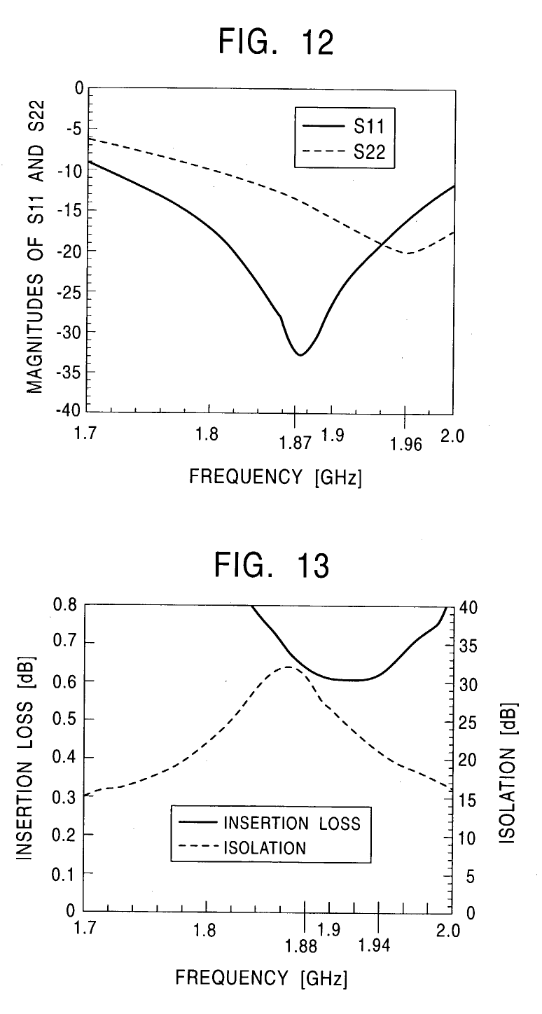

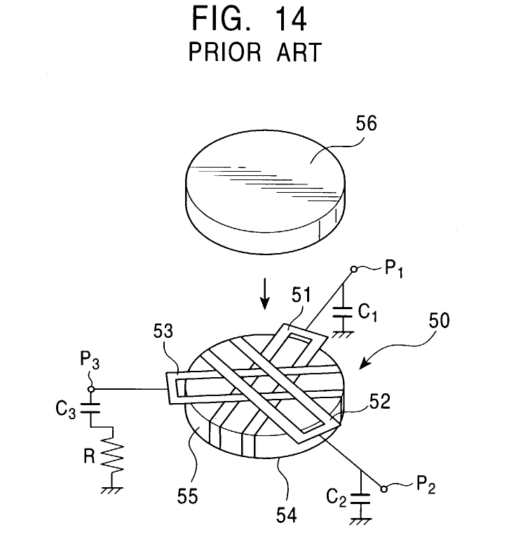

In the isolator of experiment example 2, as shown in FIG. 12, the center frequencies of the reflection coefficients S11 and S22 are in the vicinity of 1.87 GHz and 1.96 GHz, respectively, and it can be seen that the center frequencies deviate by approximately 0.09 GHz (90 MHz). Furthermore, as shown in FIG. 13, the insertion loss becomes a minimum in a range in which the frequency is in a range of 1.88 to 1.94 GHz, and it can be seen that each of the center frequencies of the reflection coefficients S11 and S22 of FIG. 12 deviates from this range.

As a result, since the isolator of experiment example 2 operates at a frequency deviated from the center frequencies of the reflection coefficients S11 and S22, the insertion loss becomes larger, and the signal transmission efficiency is decreased.

It can be seen from the above that, as a result of making the capacitance difference between the capacitors C1 and C2 to be approximately 2.8%, it is possible to make the center frequencies of the reflection coefficients of the center conductors on the input and output sides nearly match each other.

(Second Embodiment)

For the isolator having the configuration shown in FIGS. 6 and 7, reflection coefficients and transmission coefficients in a case where the capacitances of the capacitors C1 and C2 were changed were measured.

In the isolator shown in FIGS. 6 and 7, as a plate-shaped magnetic-material, a magnetic material composed of yttrium iron garnet ferrite (YIG ferrite) in the shape having a vertical width of 2 mm, a horizontal width of 3.4 mm, and a thickness of 0.35 mm, shown in FIG. 8, was used. For the first, second, and third center conductors, copper foils having a line length of 3.6 mm, a total width of 800 μm, a slit width of 400 μm, a substantial line width of 400 μm, and a thickness of 0.05 mm were used. As shown in FIG. 9, the first, second, and third center conductors were formed so as to extend in three directions from a common electrode having a vertical width of 2 mm, a horizontal width of 3.4 mm, and a thickness of 0.05 mm.

The common electrode was laminated on the bottom of the plate-shaped magnetic material, and the first, second, and third center conductors were bent over the obverse-surface side of the plate-shaped magnetic-material, thereby manufacturing a magnetic assembly shown in FIGS. 6 and 7.

Next, the capacitor C1 was mounted on the first port P1 (input port), which is a front end of the first center conductor; the capacitor C2 was mounted on the port part P2 (output port), which is a front end of the second center conductor; and the capacitor C3 was mounted on the port part P3, which is a front end of the third center conductor; the terminating resistor R was mounted on the capacitor C3; and a permanent magnet was laminated on the plate-shaped magnetic material. In this state, the above components were placed inside a closed magnetic circuit formed of an upper yoke and a lower yoke, thereby an isolator of experiment example 3, shown in FIGS. 6 and 8, was produced.

For the isolator of experiment example 3, the capacitance of the capacitor C1 was set to 12.5 pF, the capacitance of the capacitor C2 was set to 12.2 pF, the capacitance of the capacitor C3 was set to 17.8 pF, and the terminating resistance was set to 39 Ω. The capacitance difference between the capacitors C1 and C2 was 2.4%.

For the isolator of experiment example 3, a reflection coefficient S11 in the first center conductor, a reflection coefficient S22 in the second center conductor, and transmission coefficients S21 and S12 were determined. The results are shown in Table 1 below.

TABLE 1

Experiment Example 3

| Capacitor C1 (pF) | | 12.5 |
|---|---|---|
| Capacitor C2 (pF) | | 12.2 |
| Reflection | Magnitude | 23.93 |
| Coefficient (S11) | Center Frequency (GHz) | 1.001 |
| Reflection | Magnitude | 29.88 |
| Coefficient (S22) | Center Frequency (GHz) | 1.001 |
| Transmission | Magnitude | 19.42 |
| Coefficient (S21) | Center Frequency (GHz) | 0.95 |
| Transmission | Magnitude | 0.657 |
| Coefficient (S12) | Center Frequency (GHz) | 1.001 |

It can be seen from Table 1 that both the center frequencies of the reflection coefficients S11 and S22 indicate 1.001 GHz, and that the reflection coefficients S11 and S22 match each other.

Therefore, also, in the isolator having the configuration shown in FIGS. 6 and 7, by adjusting the capacitance difference between the capacitors C1 and C2, it is possible to cause the center frequencies of the reflection coefficients match each other and possible to improve the signal transmission efficiency.

Table 2 shows the capacitance of each of the capacitors C1 and C2 in a case where the difference between the center frequencies was adjusted to 0. As is clear from Table 2, the center frequencies can be made to match each other by making the capacitance difference between the capacitors C1 and C2 to be greater than or equal to 2.2% and less than 5.5%.

TABLE 2

| | Capacitance of | Capacitance of | Capacitance |
|---|---|---|---|
| Sample | Capacitor C1 | Capacitor C2 | Difference |
| No. | (pF) | (pF) | (%) |
| 1 | 5.5 | 5.2 | 5.5 |
| 2 | 8.7 | 8.4 | 3.4 |
| 3 | 9 | 8.8 | 2.2 |
| 4 | 12.5 | 12.2 | 2.4 |
| 5 | 13.1 | 12.8 | 2.3 |
| 6 | 13.2 | 12.9 | 2.3 |
| 7 | 13.4 | 13.1 | 2.2 |
| 8 | 13.8 | 13.5 | 2.2 |

As has thus been described in detail, according to the nonreciprocal circuit device of the present invention, since the capacitance of the capacitor connected to one of the center conductors which intersects in a portion further away from the plate-shaped magnetic-material is larger than the capacitance of the capacitor connected to the other center conductor which intersects in a portion closer to the plate-shaped magnetic-material, the center frequencies of the reflection coefficients of a pair of center conductors can be made to match each other. As a result, the insertion loss of the nonreciprocal circuit device can be reduced, and the signal transmission efficiency can be improved.

What is claimed is:

1. A nonreciprocal circuit device comprising:
a plate-shaped magnetic material;
a common electrode arranged on one side surface of the plate-shaped magnetic material;
three center conductors which extend in three directions from the outer peripheral portion of the common electrode, said three center conductors being bent over the other side surface of said plate-shaped magnetic material in such a manner as to cover the plate-shaped magnetic-material, and the center conductors mutually intersecting at a predetermined angle on said other side surface; and
capacitors, each one being connected to a corresponding center conductor,
wherein, with regard to one of a pair of center conductors among the three center conductors, the capacitance of the capacitor connected to one of the center conductors which intersects in a portion further away from said plate-shaped magnetic-material among the pairs of center conductors is larger than the capacitance of the capacitor connected to the other center conductor.

2. A nonreciprocal circuit device according to claim 1, wherein, when the capacitance of the capacitor connected to said one center conductor is denoted as Cap1 and the capacitance of the capacitor connected to said other center conductor is denoted as Cap2, the capacitance difference expressed by (Cap1−Cap2)/Cap1×100% is preferably in a range of 1% to 10%.

3. A nonreciprocal circuit device according to claim 1, wherein, for said pair of center conductors, the frequencies at which the reflection coefficient in each center conductor becomes a minimum are made to match each other.

4. A nonreciprocal circuit device according to claim 1, wherein, for said three center conductors, the frequencies at which the reflection coefficient in each center conductor becomes a minimum are made to match one another.
